(19) United States
(12) Patent Application Publication
(10) Pub. No.: US 2008/0036828 A1
(43) Pub. Date: Feb. 14, 2008

(54) LIQUID CONTAINER

(75) Inventors: Hisashi Koike, Suwa-shi (JP); Kazuhide Kubota, Nagano-ken (JP); Kazuyo Haraguchi, Matsumoto-shi (JP); Mitsuto Yanagisawa, Matsumoto-shi (JP); Kazuhide Nakamura, Nagano-ken (JP); Kentaro Miyazaki, Shiojiri-shi (JP); Yuki Ono, Chino-shi (JP)

Correspondence Address: SUGHRUE MION, PLLC, 2100 Pennsylvania Avenue, N.W., Washington, DC, 20037, US

(73) Assignee: SEIKO EPSON CORPORATION, Tokyo (JP)

(21) Appl. No.: 11/735,090

(22) Filed: Apr. 13, 2007

(30) Foreign Application Priority Data
Apr. 13, 2006 (JP) 2006-111254

(51) Int. Cl. B41J 2/175

(52) U.S. Cl. 347/86

(57) ABSTRACT

[Object] To provide a liquid container allowing improvement of its dimensional precision.

[Solving Means] An ink cartridge 22 as a liquid container includes a case 23 having a case body 30 and a lid case 32, and a moving member 36 attached to a surface of a flexible ink pack 25 housed in the case 23. The moving member 36 assumes different positional attitudes inside the case 23 in accordance with the volume of the ink pack 25 that is gradually reduced as the ink therein is consumed, so as to be detected by a detector provided in a printer when the moving member 36 assumes a positional attitude indicating that the ink pack 25 has become empty of ink. The case body 30, lid case 32, and moving member 36 are molded of a material containing at least polylactic acid to achieve a low mold shrinkage rate.

### TECHNICAL FIELD

The present invention relates to a liquid container to be mounted on a liquid ejecting apparatus such as an ink jet printer.

### BACKGROUND ART

An ink jet printer (referred to hereinafter simply as “printer”) is a known example of a liquid ejecting apparatus for ejecting ink (liquid) from a recording head (liquid ejecting head) to a target. Such a printer has a recording head mounted on a reciprocating carriage and adapted to be supplied with ink from an ink cartridge (liquid container) that is usually mounted in a specific area (on the carriage for example) of the printer.

In another type of printer (so-called off-carriage type), in which an ink cartridge is mounted in an area other than the carriage, pressurized air is delivered from a booster pump to the ink cartridge to apply pressure to an ink pack (liquid storage bag) housed therein to forcibly supply ink through a tube (liquid supply passage) to the recording head. When the ink pack is found to have become empty of ink, the used-up ink cartridge is replaced with a new ink cartridge (refer to Patent Document 1 for example).

The ink cartridge disclosed in Patent Document 1 has a plate-like moving member attached to a surface of the ink pack housed in the case. More specifically, this moving member is provided so as to be capable of assuming different positional attitudes inside the case in accordance with the deformation of the ink pack as the ink contained therein is gradually consumed. When the ink pack becomes empty of ink, the moving member partially protrudes out of the case through a through hole formed in the case and touches a detector disposed outside the case to actuate the detector.

[Patent Document 1] Japanese Unexamined Patent Application Publication No. 6-328706

### DISCLOSURE OF THE INVENTION

### Problems to be Solved by the Invention

In the ink cartridge as in Patent Document 1, the case and the moving member are usually molded of a typical synthetic resin. Unfortunately, typical synthetic resins have high mold shrinkage rates and molded components tend to warp considerably and are difficult to achieve a high dimensional precision. In particular, if the moving member is molded with low dimensional precision, it cannot be detected with high accuracy by the detector. Accordingly, there has been a need for improvement in dimensional precision of the moving member.

The present invention is directed to address such a problem found in the related art. An object of the present invention is to provide a liquid container allowing improvement of dimensional precision.

### Means for Solving the Problem

To achieve the above object, a liquid container of the present invention has a plurality of members including at least one member molded of a material containing at least polylactic acid.

According to the present invention, it is possible to improve the dimensional precision of the members by molding at least one of the members of a material containing at least polylactic acid, because polylactic acid has a low mold shrinkage rate compared with other typical synthetic resins such as polyacetal for example.

In the liquid container of the present invention, the members include a case detachably mounted in a liquid ejecting apparatus having a liquid ejecting head for ejecting liquid, and a moving member attached to a surface of a flexible liquid storage bag housed in the case. The moving member assumes different positional attitudes in accordance with the volume of the liquid storage bag that is gradually reduced as the liquid contained therein is consumed, so as to be detected by a detector provided in the liquid ejecting apparatus when the liquid container becomes empty of ink. At least the moving member is molded of a material containing at least polylactic acid.

According to the present invention, if the moving member, among others, is molded of a material containing at least polylactic acid, it is possible to improve the accuracy of detection of the moving member by the detector which relies on the positional attitude of the moving member for its detection.

In the liquid container of the present invention, the case has a through hole formed in an area facing the area in which the detector is disposed, while the moving member has a projecting tip formed so as to be protruded out of the case through the through hole and detected by the detector when the liquid storage bag becomes empty of ink.

According to the present invention, the detector disposed outside the case detects the projecting tip that is protruded through the through hole. It is thereby possible to reliably detect with a simple structure that the liquid storage bag has become empty of liquid.

In the liquid container of the present invention, the members also include a case that is detachably mounted in the liquid container mounting unit in the liquid ejecting apparatus having a liquid ejecting head for ejecting liquid. The case is molded of a material containing at least polylactic acid.

According to the present invention, if the case, among others, is molded of a material containing at least polylactic acid, the dimensional precision of the case is improved. It is thereby possible to facilitate mounting and demounting of the liquid container in and from the liquid container mounting unit in the liquid ejecting apparatus.

In the liquid container of the present invention, the case includes a bottom-closed-box-like case body and a lid case attached to an opening of the case body. At least one of the case body and the lid case is molded of a material containing at least polylactic acid.

According to the present invention, if at least the case body is molded of a material containing at least polylactic acid, the dimensional precision of the case body is improved. It is thereby possible to facilitate mounting and demounting of the liquid container in and from the mounting unit in the liquid ejecting apparatus. Alternatively, if at least the lid case is molded of a material containing at least polylactic acid, the dimensional precision of the lid case is improved. It is thereby possible to facilitate attachment and detachment of the lid case to and from the case body.

### BEST MODE FOR CARRYING OUT THE INVENTION

An embodiment of the present invention, in which a liquid ejecting apparatus of the present invention is embodied as an ink jet printer, will now be described with reference to the accompanying drawings. In the following description, references to the “front-rear direction,” “up-down direction,” and “left-right direction” are made based on FIG. 1, unless otherwise specified.

As shown in FIG. 1, an ink jet printer 11 as a liquid ejecting apparatus has a frame 12 which is rectangular in shape as viewed from the top. Inside the frame 12, there is disposed a platen 13 onto which recording paper P to be printed upon is fed from a paper feeding mechanism (not shown). Inside the frame 12, there is also disposed a rod-like guide member 14 extending above the platen 13, in parallel with the length direction of the platen 13.

The guide member 14 supports a carriage 15 so as to enable its reciprocation along the axis of the guide member 14. The carriage 15 is in drivable connection with a carriage motor 18 disposed on the back of the frame 12, via an endless timing belt 17 stretched between a pair of pulleys 16 disposed on the inner rear surface of the frame 12. When driven by the carriage motor 18, the carriage 15 reciprocates along the guide member 14.

On the carriage 15, there are provided a plurality of valve units 20 for supplying ink in the form of liquid at an adjusted pressure to a recording head 19. The number of valve units 20 corresponds to the number of ink colors (types) used in the ink jet printer 11 (four in this embodiment). The recording head 19 as a liquid ejecting head is disposed on a surface of the carriage 15 facing the platen 13. The recording head 19 is equipped with nozzles (not shown) on its bottom surface and with piezoelectric elements (not shown) housed therein. The nozzles are adapted to eject ink droplets onto the recording paper P fed onto the platen 13 to perform printing when the piezoelectric elements are driven.

At the right end of the frame 12 in FIG. 1, a cartridge holder 21 as a liquid container mounting unit is disposed. On the cartridge holder 21, there are detachably mounted a plurality (four in this embodiment) of ink cartridges 22 as liquid containers. Each ink cartridge 22 has a case 23 which is rectangular in cross-sectional shape and forms an air chamber 24 therewithin, in which an ink pack 25 as a liquid storage bag made of a flexible film is housed. The ink packs 25 are filled with inks of different colors.

In the vicinity of the cartridge holder 21 located at the right end of the frame 12 in FIG. 1, a booster pump 26 is provided. The booster pump 26 is adapted to be in communication with the ink cartridges 22 through respective air supply pipes 27 when the ink cartridges 22 are mounted in the cartridge holder 21. One end of each air supply pipe 27 extends through the case 23 of the corresponding ink cartridge 22 into the air chamber 24.

The ink cartridges 22 are adapted to be in communication with the respective valve units 20 through the respective ink supply pipes 28 when the ink cartridges 22 are mounted in the cartridge holder 21. The booster pump 26 is adapted to supply pressurized air to the air chambers 24 of the ink cartridges 22 through the respective air supply pipes 27 when the booster pump 26 is actuated.

Each ink pack 25 is adapted to be collapsed by the pressure applied thereto by the pressurized air fed into the air chamber 24 so that the ink contained therein is supplied through the associated ink supply pipe 28 to the associated valve unit 20. At the home position of the carriage 15, which is located near the right end of the frame 12 in FIG. 1, a maintenance unit 29 is disposed for maintenance operations such as cleaning of the recording head 19.

Next, the structure of the ink cartridge 22 will be described in detail.

As shown in FIG. 2, the case 23 constituting the ink cartridge 22 includes a rectangular bottom-closed-box-like case body 30 and a rectangular plate-like lid case 32 detachably attached to the case body 30 to cover an opening 31 located at the left end of the case body 30. The lid case 32 has at its rear end a pair of latching projections 33 protruding rearward and at its front end a pair of higher and lower latching claws 34 protruding rightward.

The ink pack 25 is a rectangular bag made of two flexible films having aluminum-evaporated surfaces bonded together. The ink pack 25 is equipped with a cylindrical ink delivery member 35 fitted into its rear end center to allow the ink contained therein to be delivered. The ink delivery member 35 has one end formed as an ink delivery port 35a for delivering ink, with a recessed groove 35b formed on its outer periphery to position the ink pack 25 in place. At the center of a surface of the ink pack 25 facing the lid case 32 (on the left surface in FIG. 2), a substantially rectangular plate-like moving member 36 is attached. The moving member 36 has a projecting portion 36a outwardly extending (downward in FIG. 2) from one end (lower end in FIG. 2) thereof and bent at its extreme end perpendicularly downward toward the inner bottom of the case body 30 (rightward in FIG. 2), thus forming a projecting tip 36b.

The case body 30 has a pair of latching holes 37 formed through its rear wall so as to receive the pair of latching projections 33 of the lid case 32, as well as a pair of latching recesses 38 formed in its upper and lower inner walls respectively so as to receive the pair of latching claws 34 of the lid case 32. The case body 30 also has a notch 39 formed between the latching holes 37 in the rear wall. In the notch 39, there is a protruding supporting stand 40 with a supporting recess 40a, which is semicircular as viewed from the rear, formed at one end thereof.

The case body 30 also has a rectangular through hole 41 formed in the right wall (bottom wall) thereof in an area facing the projecting tip 36b of the moving member 36. Detectors 42 (see FIG. 3) are provided inside the cartridge holder 21 (see FIG. 1) at positions facing the respective through holes 41 of the case body 30 when the ink cartridges 22 are mounted. When the projecting tip 36a of the moving member 36 touches the detector 42 (see FIG. 3), the detector 42 detects that the ink pack 25 has become empty of ink.

The case body 30, lid case 32, and moving member 36 are components molded of a mixed material (specific gravity 1.29) containing polycarbonate (PC) and polylactic acid (specific gravity 1.38) at a ratio of 1:1 by weight. This mixed material has a mold shrinkage rate of approximately 0.5%, which is exceptionally low compared with those of typical synthetic resin materials such as polyacetal (POM), the mold shrinkage rate of which is approximately 2%.

Next, a procedure of assembling the ink cartridge 22 will be described in detail.

To assemble the ink cartridge 22, the ink pack 25 is first housed inside the case body 30 as shown in FIG. 2. The ink pack 25 is positioned in place in the case body 30 by engaging the recessed groove 35b of the ink delivery member 35 with the supporting recess 40a of the case body 30. With this, the projecting tip 36a of the moving member 36 is positioned so as to face the through hole 41 of the case body 30.

Subsequently, both latching projections 33 of the lid case 32 are inserted from inside the case body 30 and engaged with the respective latching holes 37 of the case body 30. Then, both latching claws 34 of the lid case 32 are engaged with the respective latching recesses 38 of the case body 30. With this, the assembly of the ink cartridge 22 is completed.

Next, a function of the ink cartridge 22 will be described.

When a new ink cartridge 22 is mounted on the cartridge holder 21 in the ink jet printer 11, the moving member 36 extends straight in the vertical direction as shown in FIG. 3(a). As the ink in the ink pack 25 is consumed, the ink gathers due to gravity in the lower portion inside the ink pack 25, so the ink pack 25 starts to contract gradually from the upper portion. As the ink pack 25 contracts, the moving member 36 tilts with its upper end rightward as shown in FIG. 3(b). More specifically, the volume of the ink pack 25 is gradually reduced as the ink in the ink pack 25 is consumed, thereby causing the moving member 36 to assume different positional attitudes.

As the ink in the ink pack 25 is further consumed, the lower portion of the ink pack 25 contracts as well, thereby causing the projecting tip 36a of the moving member 36 to approach the through hole 41 of the case body 30. When the ink pack 25 becomes empty of ink, the projecting tip 36a of the moving member 36 protrudes out of the case 23 through the through hole 41 of the case body 30 and touches the detector 42 as shown in FIG. 3(c). With this, the detector 42 detects the projecting tip 36a of the moving member 36, thereby detecting that the ink pack 25 has become empty of ink.

According to the embodiment described above, the following effects can be obtained.

(1) Since the case body 30, lid case 32, and moving member 36 constituting the ink cartridge 22 are components molded of the mixed material containing polycarbonate (PC) and polylactic acid at a ratio of 1:1 by weight, the mold shrinkage rate can be reduced compared with the case in which these components are molded of a material composed of polyacetal (POM) for example. This allows improvement in dimensional precision of the molded components.

If the moving member 36 is molded of the above mixed material, warping of the moving member 36 can be suppressed, so the moving member 36 can be detected with a higher accuracy by the detector 42 that relies on the positional attitude of the moving member 36 for its detection.

If the case 23 (case body 30) is molded of the above mixed material, it is possible to improve the dimensional precision of the case 23 (case body 30). It is thereby possible to facilitate mounting and demounting of the ink cartridge 22 in and from the cartridge holder 21 in the ink jet printer 11.

If the lid case 32 is molded of the above mixed material, it is possible to improve the dimensional precision of the lid case 32. It is thereby possible to facilitate attachment of the lid case 32 to the case body 30.

(2) The moving member 36 has the projecting tip 36a formed so as to protrude out of the case 23 through the through hole 41 when the ink pack 25 becomes empty of ink. This enables the detector 42 disposed outside the case 23 to reliably detect that the ink pack 25 has become empty of ink simply by detecting the projecting tip 36a protruding through the through hole 41. It is thereby possible to detect with a simple structure that the ink pack 25 has become empty of ink.

(3) The above mixed material contains polycarbonate (specific gravity 1.20) and polylactic acid (specific gravity 1.38), each having a relatively high specific gravity among synthetic resins, at a ratio of 1:1 by weight and has a resultant specific gravity of 1.29, so the molded components are heavier than molded of a typical synthetic resin. If the moving member 36, among others, is molded of this mixed material, the moving member 36 can be made heavier than molded of a typical synthetic resin. It is thereby possible to improve the capability of the moving member 36 to follow the volume of the ink pack 25 that is reduced as the ink in the ink pack 25 is consumed. For reference, typical synthetic resins have these specific gravities: ABS resin 1.0, polystyrene 1.04, and polypropylene 0.9. Apparently, polycarbonate has a higher specific gravity than these synthetic resins.

(4) When incinerated, polylactic acid emits a combustion calorie remarkably lower than polyethylen and other synthetic resins, and does not produce toxic gases such as dioxin, hydrogen chloride, nitrogen oxide, and sulfur oxides. If the components of the ink cartridge 22 are molded of the above mixed material containing polylactic acid, it is possible to significantly alleviate the load on the incinerator and also reduce atmospheric pollution when the ink cartridge 22 is incinerated for disposal. These effects are more enhanced as the proportion of polylactic acid in the above mixed material increases.

(5) Polylactic acid, which is made of starch contained in corn for example, produces carbon dioxide when burnt, but the produced carbon dioxide is absorbed as a source of carbon dioxide by corns and other plants and the total amount of carbon dioxide in nature never increases. Accordingly, if the components of the ink cartridge 22 are molded of the above mixed material containing polylactic acid, the increase in nature of carbon dioxide which causes global warming can be restrained even if the ink cartridge 22 is incinerated for disposal. This effect is more enhanced as the proportion of polylactic acid in the above mixed material increases.

(6) Since the above mixed material contains polylactic acid, molded articles have an excellent shape reproducibility. When the moving member 36 is stripped off the ink pack 25 for its reuse, the moving member 36 may be deformed by the stress applied thereto when being stripped off, but quickly and easily restores its original shape.

### ALTERNATIVE EMBODIMENTS

The above embodiment may be modified as follows.
Among the case body 30, lid case 32, and moving member 36 in the above embodiment, any two (case body 30 and lid case 32 for example) may be molded of the above mixed material and the remaining one (moving member 36 for example) may be molded of a material other than the above mixed material.
Among the case body 30, lid case 32, and moving member 36 in the above embodiment, any one (moving member 36 for example) may be molded of the above mixed material and the remaining two (case body 30 and lid case 32 for example) may be molded of a material other than the above mixed material.
The above mixed material may contain polylactic acid in any proportion so far as it is contained. For example, a material 100% composed of polylactic acid may be used instead of the above mixed material.
ABS resin, polystyrene, polypropylene, and other synthetic resin may be used instead of polycarbonate in the above mixed material. Alternatively, at least one of these synthetic resins including polycarbonate may be mixed into the above mixed material.
The liquid ejecting apparatus, which is embodied as the ink jet printer 11 in the above embodiment, may be embodied as a liquid ejecting apparatus used to manufacture liquid crystal displays and other color filters or for pixel formation in organic EL displays.

### BRIEF DESCRIPTION OF THE DRAWINGS

FIG. 1 is a plan view of an ink jet printer in the embodiment.

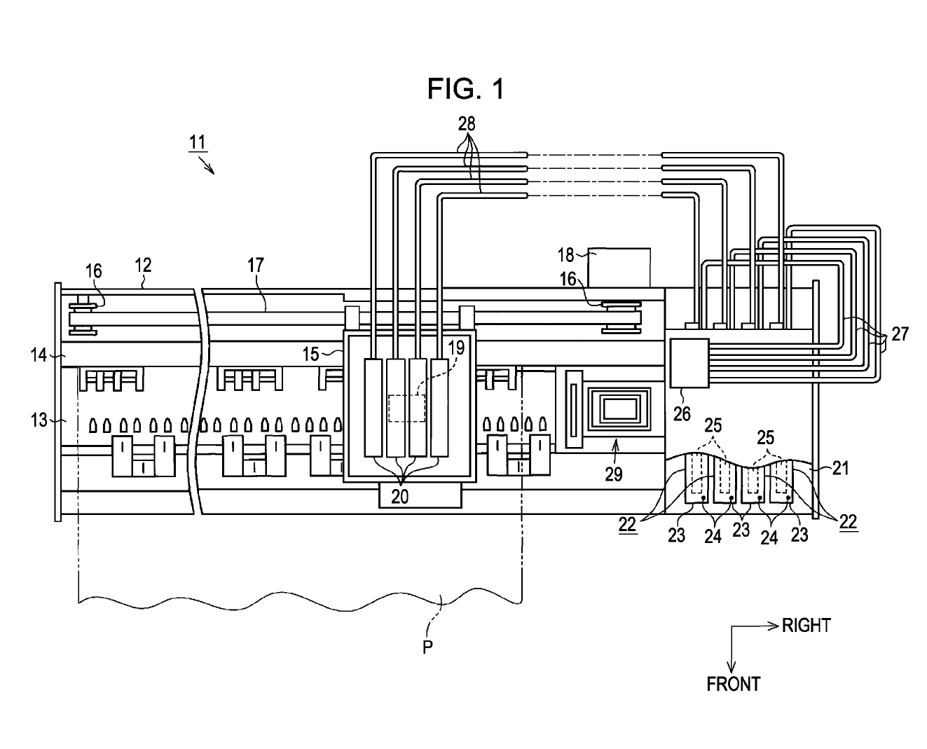

FIG. 2 is an exploded perspective view of an ink cartridge in the embodiment.

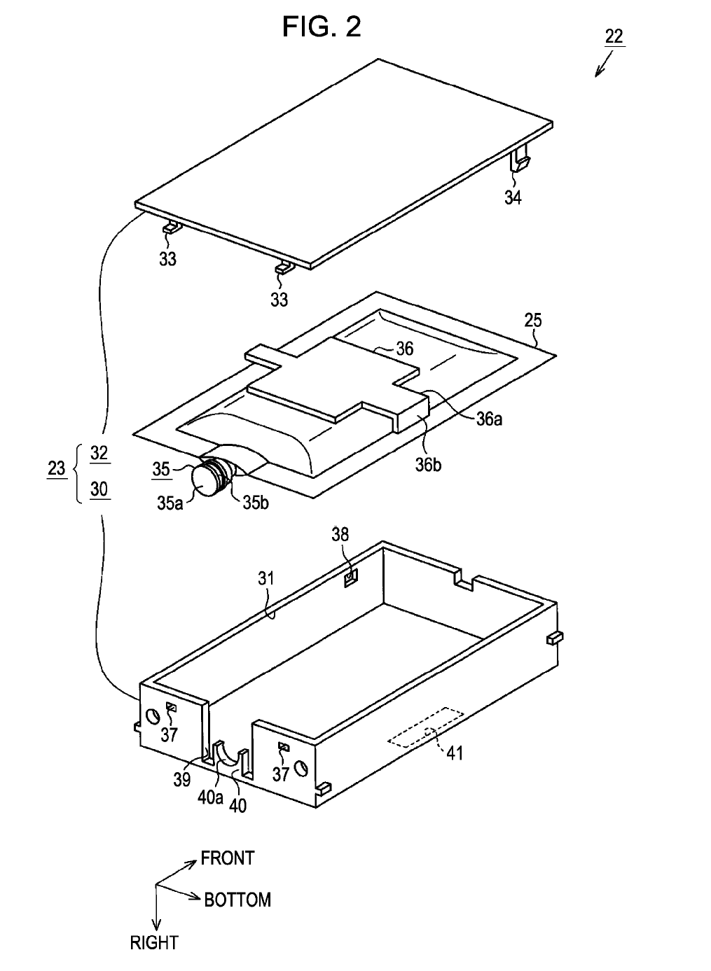

FIG. 3(a) is a sectional view of a new ink cartridge; FIG. 3(b) is a sectional view showing the ink cartridge with ink consumed to some extent; and FIG. 3(c) is a sectional view showing the ink cartridge that has become empty of ink.

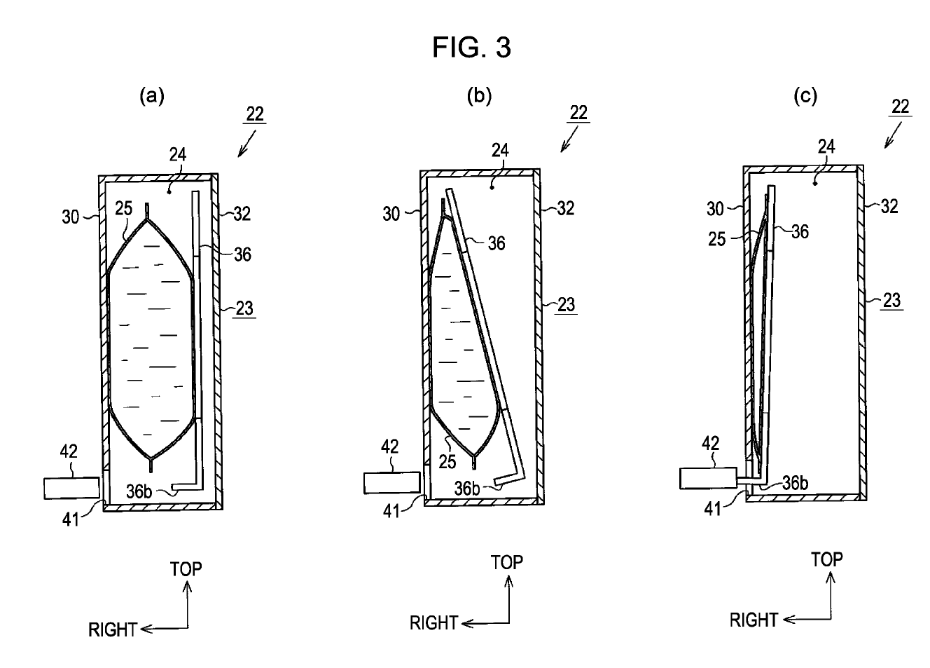

### REFERENCE NUMERALS

11: ink jet printer as a liquid ejecting apparatus
19: recording head as a liquid ejecting head
21: cartridge holder as a liquid container mounting unit
22: ink cartridge as a liquid container
23: case
25: ink pack as a liquid storage bag
30: case body
31: opening of the case body
32: lid case
36: moving member
36b: projecting tip
41: through hole
42: detector

1. A liquid container including a plurality of members,
wherein at least one of the members is molded of a material containing at least polylactic acid.

2. The liquid container according to claim 1,
wherein the members include a case being detachably mounted in a liquid ejecting apparatus having a liquid ejecting head for ejecting liquid, and a moving member being attached to a surface of a flexible liquid storage bag housed inside the case;
wherein the moving member assumes different positional attitudes inside the case in accordance with a volume of the liquid storage bag that is reduced as liquid in the liquid storage bag is consumed so as to be detected by a detector provided in the liquid ejecting apparatus when the moving member assumes a positional attitude indicating that the liquid storage bag has become empty of liquid;
wherein at least the moving member is molded of a material containing at least polylactic acid.

3. The liquid container according to claim 2,
wherein the case has a through hole formed in an area corresponding to an area in which the detector is disposed, while the moving member has a projecting tip formed so as to protrude out of the case through the through hole and be detected by the detector when the liquid storage bag becomes empty of liquid.

4. The liquid container according to claim 1,
wherein the members include a case detachably mounted in a liquid container mounting unit of the liquid ejecting apparatus having the liquid ejecting head for ejecting liquid;
wherein the case is molded of a material containing at least polylactic acid.

5. The liquid container according to claim 4,
wherein the case comprises a bottom-closed-box-like case body and a lid case attached to an opening of the case body;
wherein at least one of the case body and the lid case is molded of a material containing at least polylactic acid.
